(19) United States
(12) Patent Application Publication
(10) Pub. No.: US 2023/0082852 A1
(43) Pub. Date: Mar. 16, 2023

(54) METHOD AND SYSTEM FOR SMART HOME CONTROL IN AN INTERNET OF THINGS (IOT) ENVIRONMENT

(71) Applicant: SAMSUNG ELECTRONICS CO., LTD., Suwon-si (KR)

(72) Inventors: Ankit TAPARIA, Bengaluru (IN); Mugula SATYA SHANKAR KAMESHWAR SHARMA, Bengaluru (IN); Bhargav KRISHNAMURTHY, Bengaluru (IN)

(73) Assignee: SAMSUNG ELECTRONICS CO., LTD., Suwon-si (KR)

(21) Appl. No.: 17/858,597

(22) Filed: Jul. 6, 2022

Related U.S. Application Data
(63) Continuation of application No. PCT/KR2022/007411, filed on May 25, 2022.

(30) Foreign Application Priority Data
Sep. 8, 2021 (IN) 202141040783

(51) Int. Cl. H04L 12/28; G06F 3/0482; H04M 1/724

(52) U.S. Cl. CPC H04L 12/2838; G06F 3/0482; H04M 1/724; H04L 2012/2841

(57) ABSTRACT

A method for enhanced smart home control in an Internet of Things (IoT) environment includes detecting user actionable buttons present in a quick-setting menu of a mobile device, detecting one or more IoT devices within a pre-defined proximity of the mobile device, and mapping operation control parameters of each of the one or more IoT devices that are detected with one or more user actionable buttons of the user actionable buttons present in the quick setting menu of the mobile device to allow control, through the quick-setting menu, of the one or more IoT devices by the one or more user actionable buttons.

### CROSS-REFERENCE TO RELATED APPLICATION(S)

This application is based on and claims priority under 35 U.S.C. § 119 to Indian Patent Application No. 202141040783, filed on Sep. 8, 2021, in the Indian Patent Office, the disclosure of which is incorporated by reference herein in its entirety.

### BACKGROUND

### 1. Field

This disclosure generally relates to computing systems and in particular relates to control of Internet of Things (IoT) devices by a mobile device.

### 2. Description of Related Art

With an increase in number of Internet of Things (IoT) devices in a Smart Home environment, an overhead of changing settings of the IoT device becomes cumbersome. There are many steps required to change the settings in the IoT device. For example, to change a particular setting of the IOT device, either a plugin of the IOT device needs to opened through a dedicated application or a third party software application is needed to change the settings of the IOT device. Regardless, five or more steps (e.g., taps) are typically required to access and change a given setting.

Additionally, setting control methods according to the related art require that, for every IoT device, a separate application must be opened for changing the settings of the IoT device.

### SUMMARY

Provided are a method and system for enhanced control of Internet of Things (IoT) devices by a mobile device.

Additional aspects will be set forth in part in the description which follows and, in part, will be apparent from the description, or may be learned by practice of the presented embodiments.

In accordance with an aspect of the disclosure, there is provided a method comprising detecting, by a processor of a mobile device, a plurality of user actionable buttons present in a quick-setting menu of the mobile device; detecting, by the processor, one or more Internet of Things (IoT) devices within a pre-defined proximity of the mobile device; and mapping, by the processor, a plurality of operation control parameters of each of the one or more IoT devices that are detected with one or more user actionable buttons of the plurality of user actionable buttons present in the quick setting menu of the mobile device to allow control, through the quick-setting menu, of the one or more IoT devices by the one or more user actionable buttons.

In accordance with another aspect of the disclosure, there is provided a system comprising an ultra wide-band (UWB) sensor configured to detect one or more IoT devices within a pre-defined range of a mobile device, and a processor communicatively coupled to the UWB sensor. The processor is configured to identify one or more operation control parameters of each IoT device of the one or more IoT devices that are detected by the UWB sensor; identify user actionable buttons in a quick setting menu of the mobile device; and map the one or more operation control parameters of the one or more IoT devices that are detected by the UWB sensor onto one or more user actionable buttons of the user actionable buttons in the quick setting menu to allow user access of the one or more IoT devices from the quick setting menu.

In accordance with another aspect of the disclosure, there is provided a method comprising detecting, by a processor of an ultra wide-band (UWB) based mobile device, a selection of a quick setting control on the UWB based mobile device while the UWB based mobile device is pointed toward at least one Internet of Things (IoT) device in an IoT environment; determining, by the processor, at least one operational state for the at least one IoT device, the at least one operational state being linked with at least one functionality of the quick setting control that is selected; and modifying, by the processor, a current state of the at least one IoT device to the at least one operational state that is determined

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate a setting change method, according to the related art;

FIGS. 2A and 2B illustrate examples of methods for enhanced Smart Home control in an IoT environment according to various embodiments;

FIG. 3 illustrates an ultra-wideband (UWB) based IOT Device Control using a quick panel of a mobile device, according to an embodiment;

FIG. 4 illustrates a Device Data Abstraction Module of FIG. 3, according to an embodiment;

FIG. 5 illustrates steps of an operation subsequent to an operation depicted in FIG. 3 according to an embodiment;

FIG. 6 illustrates a mapping module of FIG. 5, according to an embodiment;

FIGS. 7A-7C illustrate an intuitive mapper module of FIG. 6, according to an embodiment;

FIGS. 8A-8E illustrate an example use-case of usage of the intuitive mapper module and the one to one mapper module according to an embodiment;

FIG. 9 illustrates steps of an operation subsequent to an operation depicted in FIG. 6, according to an embodiment;

FIGS. 10A-10B further illustrate a device-identifier and an action-identifier according to an embodiment;

FIGS. 11A-11B illustrate phone quick-panel controls and quick-panel as IoT Controls according to an embodiment;

FIGS. 12A-12B illustrate an example IoT control disassociation according to an embodiment;

FIGS. 13A-13C depict examples of controlling common IoT Controls from a Quick Panel, according to an embodiment;

FIGS. 14A-14B depict an example of providing one-touch access to a customizable quick panel according to an embodiment;

FIGS. 15A-15B and 16A-16B depict a comparison between related art methods and methods according to various embodiments; and

FIG. 17 illustrates yet another exemplary implementation in accordance with an embodiment.

### DETAILED DESCRIPTION

As discussed above, in the related art, there are many steps required to change the settings in an IoT device. For example, to change a particular setting of the IOT device, either a plugin of the IOT device needs to opened through a dedicated application or a third party software application is needed to change the settings of the IOT device. Regardless, five or more steps (e.g., taps) are typically required to access and change a given setting.

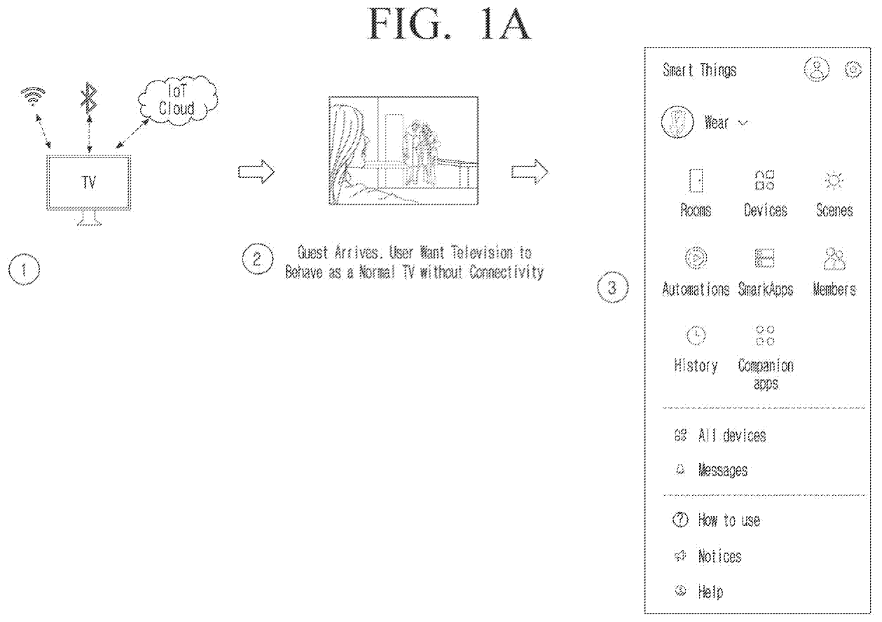

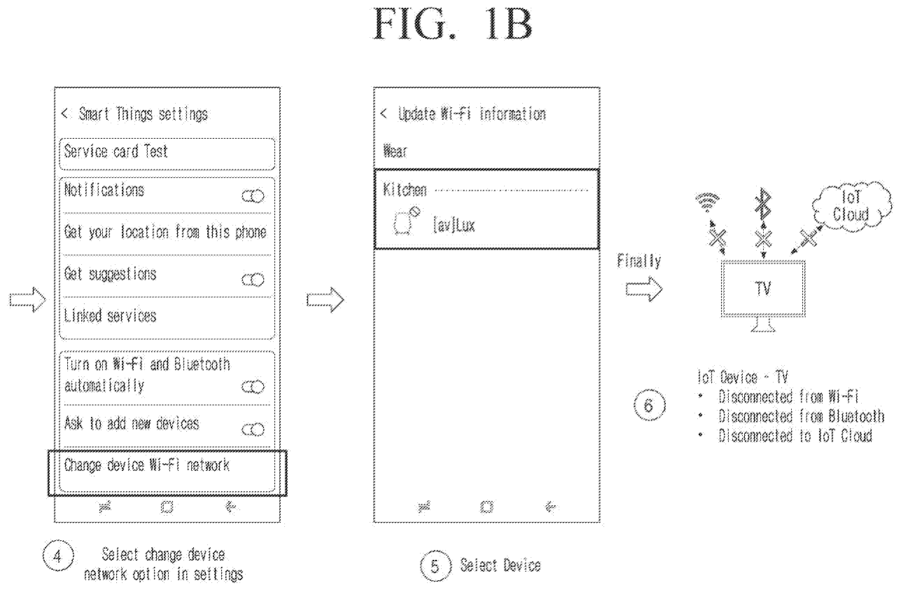

Take, for example, an operation to change a setting to bring the IoT Device to a state of Disconnected Connectivity (e.g., Flight Mode), for example in a situation in which guests are visiting and an owner of the Smart-Home IoT device wants the Smart-Home IoT device to act as a simple device. There are a lot of process steps involved, as illustrated in FIGS. 1A-1B.

FIGS. 1A-1B illustrate operations of a related art setting change process. The related art method requires Steps 1-6:

Step 1: IoT Device (e.g., TV) connected to Wi-Fi, connected to Bluetooth, connected to an IoT Cloud.

Step 2: Guest Arrives. User Want Television to behave as a Normal TV without Connectivity.

Step 3: Select settings (e.g., upper right corner) in SmartThings app.

Step 4: Select change device Wi-Fi network option in settings.

Step 5: Select Device.

Step 6: IoT Device (e.g., TV) disconnected from Wi-Fi, disconnected from Bluetooth, disconnected from IoT Cloud.

Accordingly, the related art provides a device control method that is applied to a mobile terminal by which a user will be able to control the device using an external application. The related art thus mandates that for every device a separate application will be opened for controlling.

In accordance with various embodiments, there is provided a method of enhanced Smart Home control in an IoT environment. The method comprises detecting a plurality of user actionable buttons present in a quick-setting menu of a mobile device, detecting one or more IoT devices within a pre-defined proximity of the mobile device and mapping a plurality of operation control parameters of each of the detected IoT devices with one or more user actionable buttons within the quick-setting menu of the mobile device for allowing user-access of the IoT devices through the actionable buttons in the quick-setting menu.

In accordance with various embodiments, there is also provided a method for Smart Home control using a ultra-wideband (UWB) based mobile device. The method comprises detecting user selection of a quick setting control on the UWB based mobile device while pointing the mobile device toward at least one IoT device in an IoT environment, determining at least one operational state for the at least one IoT device linked with at least one functionality of the selected quick-setting control, and modifying the current state of IoT device to the determined at least one operational state of the IoT device.

In the description that follows to the extent possible like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of various aspects of the embodiments. Furthermore, one or more elements may have been represented in the drawings by conventional symbols, and the drawings may show only those specific details that are pertinent to understanding the embodiments so as not to obscure the drawings with details that will be readily apparent to those of ordinary skill in the art having the benefits of the description herein.

Reference will now be made to various embodiments illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are exemplary and explanatory of the present disclosure and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present disclosure. Thus, the appearances of the phrase “in an embodiment”, “in another embodiment” and similar language throughout this specification may, but do not necessarily, all refer to the same embodiment.

Various embodiments will be described below in detail with reference to the accompanying drawings.

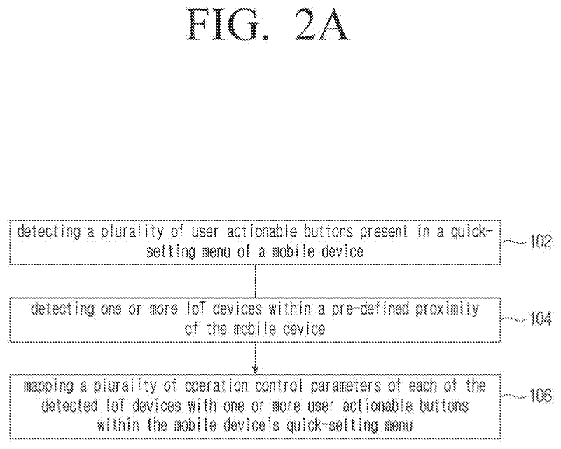

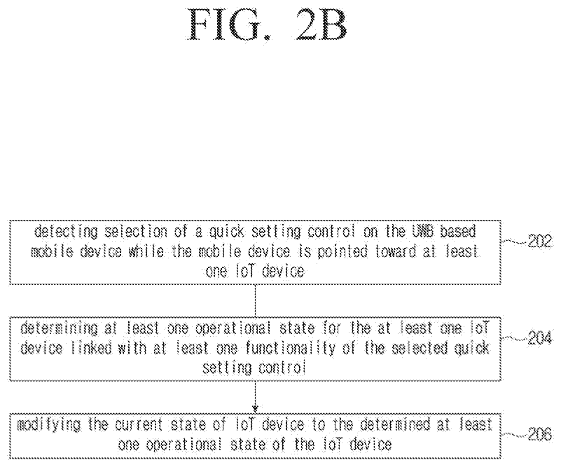

FIGS. 2A and 2B illustrate examples of methods for enhanced Smart Home control in an IoT environment according to various embodiments. As illustrated in FIG. 2A, the method comprises detecting a plurality of user actionable buttons present in a quick-setting menu of a mobile device (step 102). Throughout the present disclosure, the quick-setting menu may be interchangeably referred to as a “quick panel” or a “quick control menu”. One or more operation control parameters of each of the detected IoT devices in the proximity may be identified. The identifying of the one or more operation control parameters of each detected IoT device in the proximity may comprise fetching device data from a remote server or cloud server pertaining to the one or more detected IoT devices, and locating the detected IoT devices in the predefined proximity for updating a built-in storage of the mobile device.

Further, the method comprises detecting one or more IoT devices within a pre-defined proximity of the mobile device (step 104). The capability of the detected IoT devices in the predefined proximity is extracted, especially in a case in which the capability information of the detected IoT device is absent within the built-in storage of the mobile device. Accordingly, the built-in storage is updated with the extracted capability information. Similar capabilities of multiple IoT devices out of the extracted capabilities are correlated through a capability co-relator module.

The method further comprises mapping a plurality of operation control parameters of each of the detected IoT devices with one or more user actionable buttons within the quick-setting menu of the mobile device (step 106). The mapping allows user-access of the IoT devices through the actionable buttons in the quick-setting menu. Using a UWB sensor in the mobile device, the one or more IoT devices within the predefined proximity of the mobile device are detected. Such devices are pointed at by the user through the mobile device. That is, the user points the mobile device at each of the IoT devices within the pre-define proximity of the mobile device. Thereafter, one or more user actionable buttons are reconfigured in the quick setting menu of the mobile device as at least one control button for operating upon the detected IoT devices within the predefined proximity of the mobile device. The reconfiguring comprises mapping the operation control parameters of the detected IoT devices in the predetermined proximity with one or more user actionable buttons within the quick control menu of the mobile device for allowing user-access of the IoT devices through the actionable buttons in the quick control menu. The mapping corresponds to an intuitive mapping for mapping the actionable buttons with the device capabilities.

In some embodiments, the method may further comprise displaying a virtual layout display on the mobile device to render designated quick setting menu items acting as the actionable buttons, wherein such virtual layout display may be a reusage of an existing user interface (UI) correspond to the quick setting menu. It is noted that in some embodiments, the displaying the virtual layout display may be omitted.

In some embodiments, the method may further comprise enabling control of a selected IoT device from the quick control menu when the mobile device is pointed towards the selected IoT device. The control may be enabled based on the steps of determining an inclination between an axis of a UWB transmitter of the mobile device and a reflected signal from the IoT device. The determined inclination may be used for determining the IoT device directed at by the mobile device. Thereafter, the action command may be parsed from the mobile device for converting into a device action resource identifier (URI) of the determined IoT device for, in turn, controlling the determined IoT device. It is noted that in some embodiments, the enabling the control of the selected IoT device may be omitted.

Accordingly to yet another embodiment, the method is provided for smart home control using a UWB based mobile device. FIG. 2B illustrates an example of a method for Smart Home control using the UWB based mobile device. The method comprises detecting selection of a quick setting control on the UWB based mobile device while the mobile device is pointed toward to at least one IoT device in an IoT environment (step 202). The selection of the quick setting control on the UWB based mobile device may be a selection by a user of the UWB based mobile device. The method may further comprise determining at least one operational state for the at least one IoT device linked with at least one functionality of the selected quick setting control (step 204). The method may further comprise modifying the current state of IoT device to the determined at least one operational state of the IoT device (step 206).

As described above with reference to FIGS. 2A-2B, the method according to various embodiments enables mapping of the operation control parameters of IoT devices in the vicinity of, for example, a mobile phone, onto one or more user actionable buttons in the mobile phone's quick control panel, thereby allowing access of IoT devices from the quick control panel. Further, the method according to various embodiments enables control/modification of a desired IoT device from the mobile phone's quick control panel when the UWB enabled mobile-phone is pointed towards the desired IoT device.

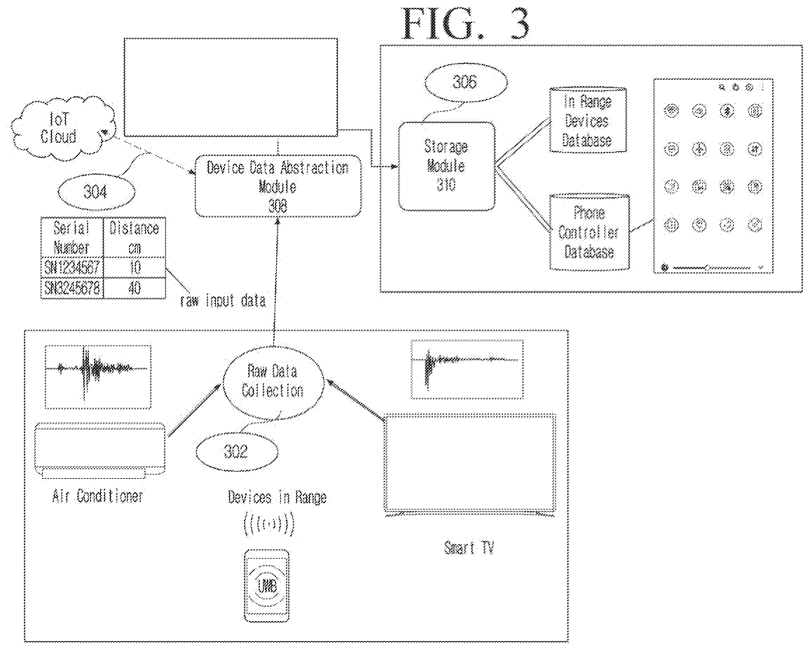

FIG. 3 illustrates a UWB based IoT Device Control using a quick-panel of a mobile device. The UWB based IoT Device Control corresponds to steps 102-104 and 202-204 in FIGS. 2A-2B. FIG. 3 illustrates how to identify other UWB Devices & associated capabilities in range of the mobile phone.

Step 302 illustrates raw data collection. Using the UWB data from the mobile phone (e.g., a smart phone), all the UWB enabled IoT devices within the UWB range are sent to a device identifier module (described later) and a Device Data Abstraction Module 308. In the example illustrated in FIG. 3, the devices in range may include an air conditioner and a Smart TV. In some embodiments, the UWB enabled devices may be scanned for in the background by a UWB radar positioning system using a transmitter in mobile device. The radius of the circular radar is a threshold distance.

Step 304 illustrates the device data abstraction module 308 fetching the device data from the IoT cloud and updating the Storage module 310 periodically so that pre-computation may be done for devices which are within the range of the mobile device and the in range device data tables may be updated. Identification of device data from the IoT cloud may be done using Serial Numbers (S/Ns) in the form of device and device type of devices in range.

Step 306 illustrates the storage module 310. A data translated to representational form by Device Data Abstraction module 308 acts as input to the storage module 310. Storage module 310 is used by other modules to get access to data and perform actions as and when requested. The storage module 310 coordinates the data flow between the sample data tables provided as follows.

A “Within Range data table” (i.e., In Range Devices database) stores data related to devices which are within range. Such table is generated dynamically in the background. The below example represents an example of the “Within Range data table” at an instance of time.

Within Range data table

| | Device | Device Type | Distance |
|---|---|---|---|
| Device ID | Name | (String) | (cm) |
| D_01 | Smart TV | Oic.d.tv | 10 |
| D_02 | Air Conditioner | Oic.d.ac | 40 |

A “Phone Controller data table” (i.e., Phone Controller database) stores all the possible quick panel action items of the Quick Panel & various phone configurations of the mobile device. For example, in the example illustrated in FIG. 3, 16 quick panel action items as shown, e.g., Wi-Fi, Bluetooth, airplane mode, etc. The “Phone Controller data table”, an example of which is illustrated below, contains all icons in the Quick Panel Phone controller table:

| ID | Capability | Phone State |
|---|---|---|
| IC_WIFI | Wifi | Wifi Cred. |
| IC_AIRPLANE | Airplane mode | OFF |
| IC_BLUETOOTH | Bluetooth | ON |
| IC_AUTO_ROTATE | Auto rotate | OFF |

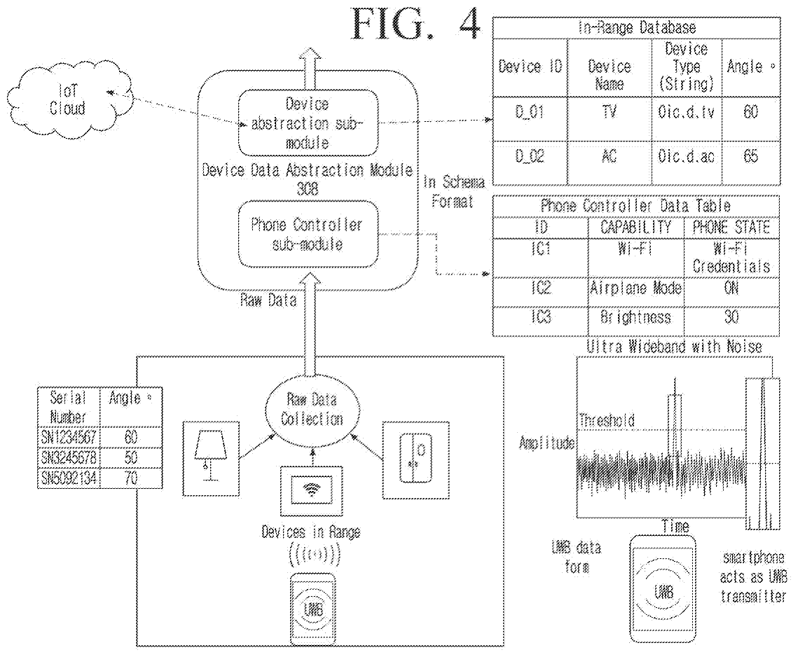

FIG. 4 further illustrates the Device Data Abstraction Module 308 of FIG. 3. The Device Data Abstraction Module 308 includes a Device Abstraction sub-module and a Phone Controller sub-module. The Device Abstraction sub-module updates in-range database (DB) with data of IoT devices that is fetched from the IoT cloud using raw data Serial Number (S/N). The Phone Controller sub-module identifies all the available Quick Panel items along with a current state of each Quick Panel item. Specifically, using the UWB data from the mobile device (e.g., smartphone), all the UWB enabled IoT devices within the UWB range are scanned. For example, in the example illustrated in FIG. 4, the devices in range may include a smart lamp, a Wi-Fi access point, and a smart refrigerator. The data the IoT devices is sent periodically whenever the mobile device scans any UWB device.

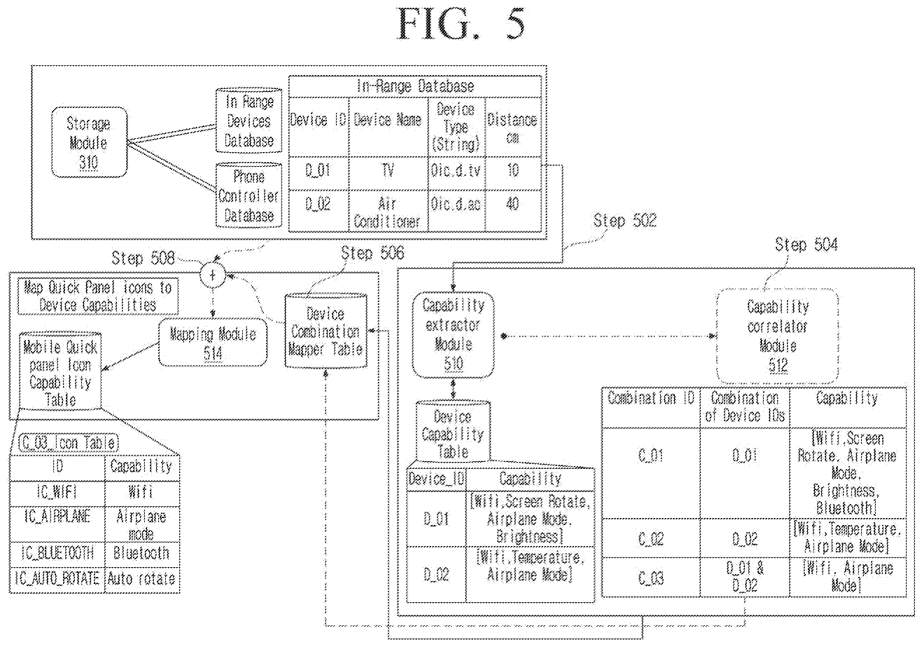

FIG. 5 illustrates steps of an operation subsequent to an operation depicted in FIG. 3 according to an embodiment.

At step 502, a Capability extractor Module 510 checks if capability already exists in Device Capability Table or not (as accessed from in the storage module 310). The Capability extractor Module 510 checks the device capability database for cache data and extracts and updates the capability of a device in database. The capability extractor module 510 accordingly extracts the capabilities of all the identified in-range devices (e.g., TV has Wi-Fi, Power, Light has Power, Brightness). In other words, the Capability extractor Module 510 obtains the information in the in-range database. A device capability Table gets updated with new data. The Capability extractor Module 510 also checks whether a single device or multiple devices have been identified. In case of multiple devices, the capabilities result is forwarded to a Capability Co-relator Module 512.

At step 504, the capability co-relator module 512 identifies the intersection between devices having various capabilities and maps the capabilities with the devices. (e.g., Power—TV, Light, Wi-Fi—AC, TV). More specifically, the Capability Co-relator Module 512 finds capabilities according to:

$${\sum }_{k = 1}^{n} ( \begin{matrix}n \\ k\end{matrix} ) Capabilities$$

where n is the number of devices in range.

At step 506, the correlated capabilities from step 504 are stored in a device combination mapper table.

At step 508, an integrator module or mapping module 514 takes the input (i.e., phone controller table) from the phone controller database and integrates the phone controller table with the capability-device mapping from step 506, such that potential quick panel items will be filtered on which action can be taken for the scanned devices. The results are stored in Mobile Quick panel icon Capability table.

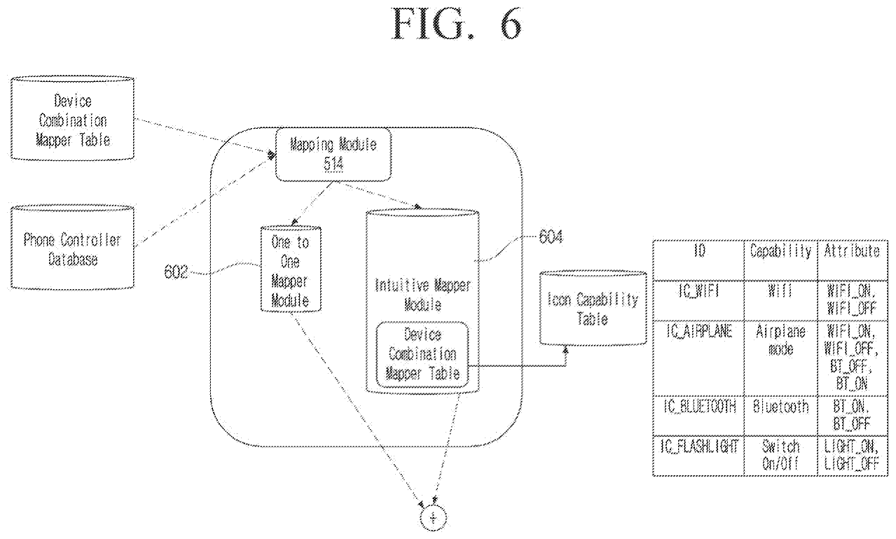

FIG. 6 illustrates the mapping-module 514 of FIG. 5, according to an embodiment. In some embodiments, the mapping module 514 may comprise a one to one mapper module and an intuitive mapper module.

As illustrated in FIG. 6, in some embodiments, the mapping module 514 takes as inputs the device combination mapper table and phone controller table from the phone controller database and integrates the phone controller table with the device combination mapper table. More specifically, in some embodiments, a one to one mapper module 602 provides direct one to one mapping between quick panel Icons and IoT Device actions which are predefined in a database including icon to capability mapping.

An intuitive mapper module 604 maps the icons to device-capabilities in an intuitive fashion based on the output of a Generic Function Modulator. For example, in scenarios controlling a Bulb, the Flashlight Capability is not the same as Bulb-Switch On/Off. In those cases, a generic-function modulator generates that Flashlight has On/Off functionality corresponding to a generic light. Such intuitive mapping plus one-to-one mapping can help in covering more icons in the quick panel. The intuitive mapper module 604 is however not used if every capability of device matches 1:1 with the mapper module. The intuitive mapper is however used, for example, in cases where some capabilities of a device (like TV Power, KIDS Mode) are not mapped directly to Main functionality on Quick Panel and may get missed.

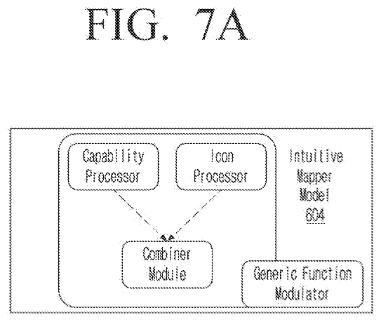

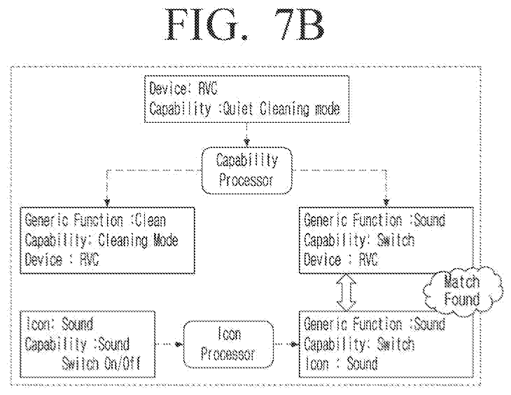

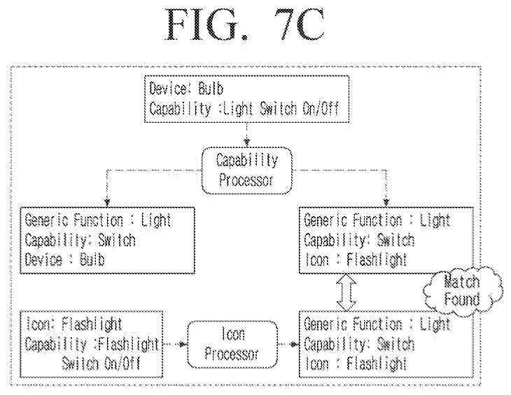

FIGS. 7A-7C illustrate an intuitive mapper module 604 of FIG. 6, according to an embodiment. The intuitive mapper module 604 comprises a generic function modulator that provides IoT Generic Functional Mapping to Quick panel Commands. In an example, Flashlight (Icon) is used for Light Switch ON/OFF. The intuitive mapper module 604 provides mapping capabilities to icons which do not directly correlate.

As indicated in FIG. 7B, the complex functionalities are broken down to a generic-form. It is determined whether there is any match at the generic functional level. The same is achieved using the Generic Function modulator (Module of Intuitive mapper). The Generic Function modulator comprises three sub modules: 1. Capability Processor, 2. Icon Processor, and 3. Combiner module.

The capability processor of FIG. 7B is used to extract a generic function from a device capability. For example, generic functions of cleaning and sound are extracted from a quiet cleaning mode so that a logical relation may be made between Sound and a robotic vacuum cleaner (RVC) Cleaning mode. In an example in FIG. 7C, generic functions of switch and flashlight are extracted from the Light Switch ON/OFF so that a logical relation may be made between Flashlight and Light Switch ON/OFF.

An Icon Processor is used to extract the generic function from the quick panel icon. For example, an icon of sound is related to a capability of sound (see, e.g., FIG. 7B), an icon of flashlight is related to a capability of Light (see, e.g., FIG. 7C). Returning to FIG. 7A, a combiner module combines the output of the Capability Processor and the Icon Processor based on a common generic function such as a sound Icon mapped to Quite Cleaning Mode, a flashlight icon Mapped to a Light Switch. The matched function is combined as in the examples described with reference to FIGS. 7B and 7C above.

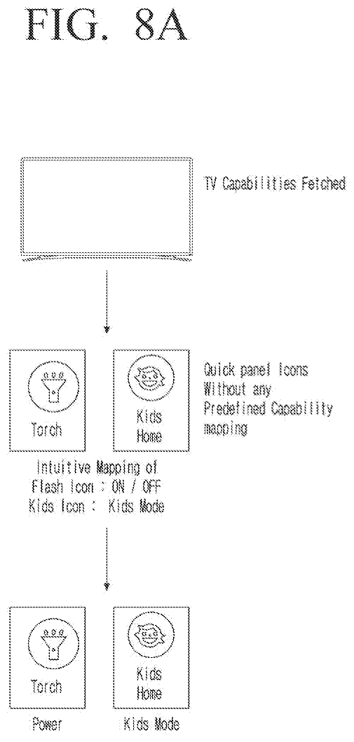

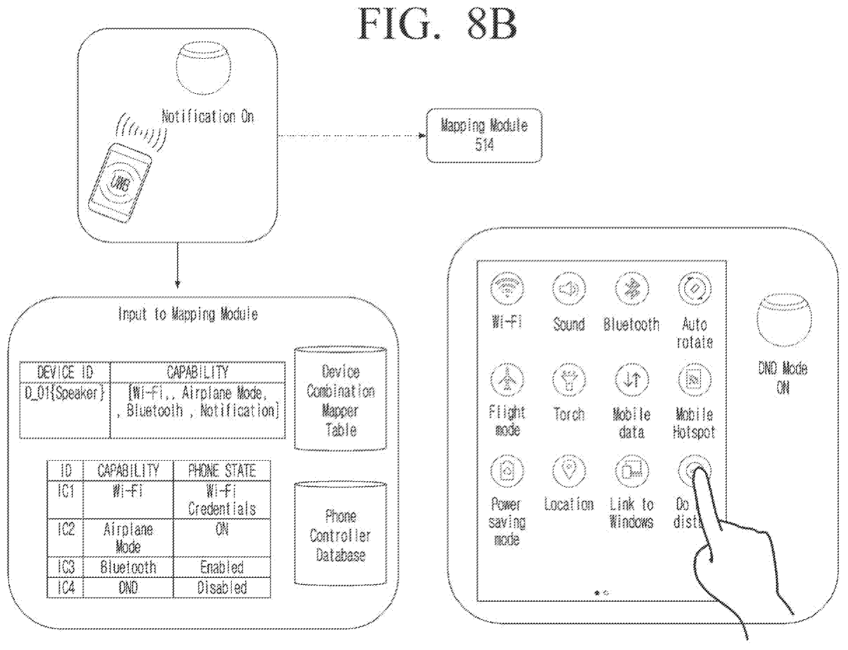

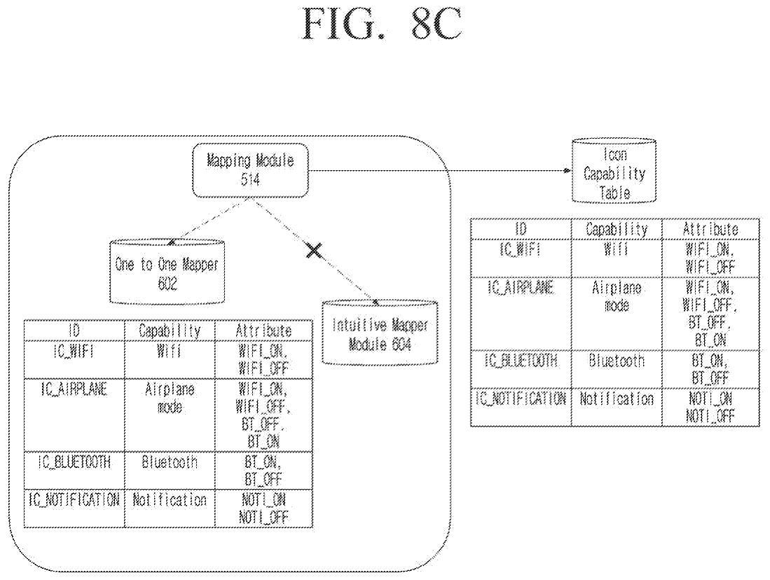

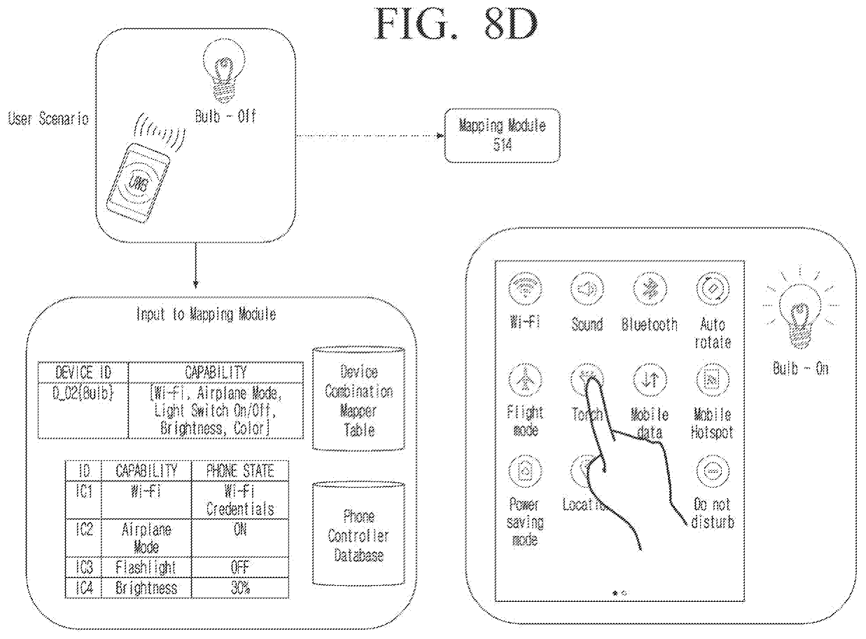

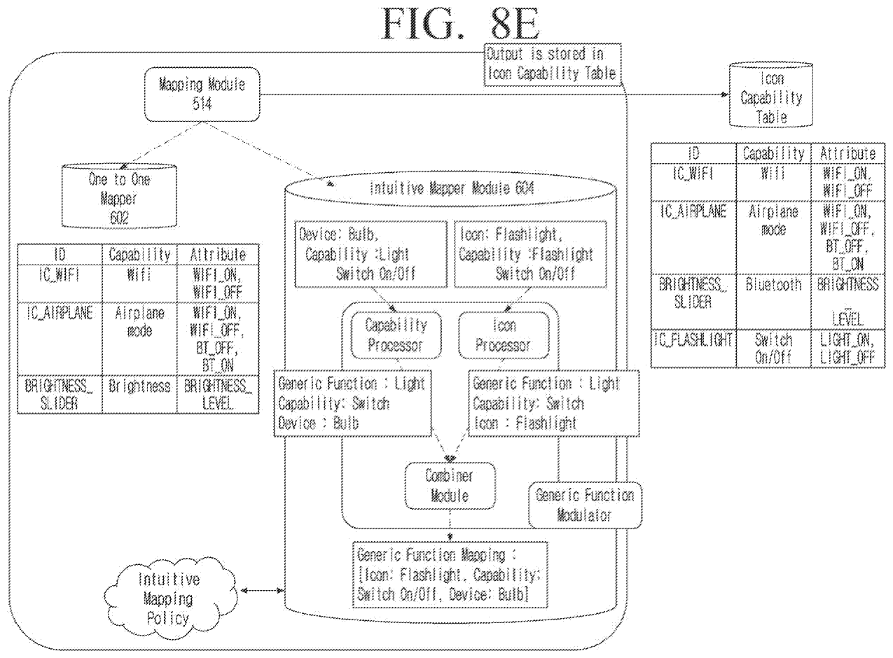

FIGS. 8A-8E illustrate an example use-case of usage of the intuitive mapper module and the one to one mapper module according to an embodiment. FIGS. 8A-8E illustrate an example use-case of the intuitive mapper module 604 and the one to one mapper module 602 as described with reference to FIGS. 6 and 7A-7C.

FIG. 8A illustrates an example of a scenario in which some capabilities of a device (like TV Power, KIDS Mode) are not mapped directly to main functionality on Quick Panel and may get missed by the one to one mapper module 602. Accordingly, the intuitive mapper module 604 maps such capabilities of the device to the quick panel. For example, a torch icon and a Kids Home icon may be quick panel icons that do not have a predefined capability mapping. The intuitive mapper module may thus may the torch icon to the TV power, and the Kids Home icon to the TV Kids Mode.

FIGS. 8B and 8C illustrate an example use-case scenario for a speaker device where the intuitive Mapper Module is not used because Speaker of Interest does not have a Capability which matches to the Quick panel. Accordingly, FIG. 8B illustrates an example operation of the one to one mapper module, where the user wants to perform a do not disturb (DND) Mode to implement a Turn OFF Notification.

FIGS. 8D and 8E illustrate another example use-case scenario where a user wants to perform the Lights On/OFF using Flash Light Quick Panel Control. Accordingly, the use-case scenario in FIGS. 8D and 8E illustrates an application of both the one to one mapper module and the intuitive mapper module. In addition, the intuitive mapping as performed are stored in the IoT cloud for future usage as an Intuitive Mapping Policy. Such mapping may also published to the IoT cloud for scaled use.

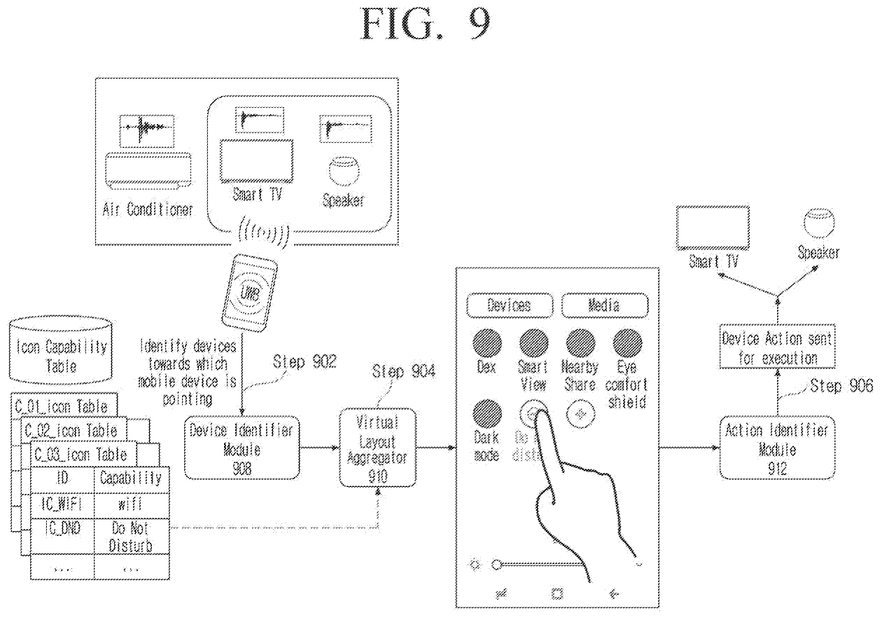

FIG. 9 illustrates steps of an operation subsequent to an operation depicted in FIG. 6, according to an embodiment. FIG. 9 illustrates steps of the operation subsequent to the operation depicted in FIG. 6 until FIG. 8A and corresponds to the step 106 and 206 of FIGS. 2A and 2B, respectively.

At step 902, a Device Identifier module 908 uses UWB data and filters only IoT devices to which the mobile device is pointing towards. The IoT devices the mobile device is pointing towards may be determined based on the directional capability of the UWB such that the mobile device discards all the devices towards which the mobile device is not pointed but that were scanned as within the range. Once the device (or) group of devices is successfully elicited, the control flows to a Virtual Layout Aggregator.

At step 904, a virtual layout aggregator 910 creates a virtual layout for display to the user where only available quick panel items will be enabled and the rest will be disabled based on data stored in the icon capability table. The virtual layout aggregator 910 uses the Icon Capability Table which is updated in the Integrator Module/Mapping module 514 in the background. In an example, C_03_Icon Table as shown in FIG. 9 includes the icon capabilities for the Combination—TV & Speaker. An icon without any device capabilities mapped to the icon are disabled and those icons that are relevant to both TV & Speaker are enabled. In response to a selection of an action button of the panel and the selected icon will be sent to Action Identifier Module.

At step 906, an action identifier module 912 parses the user action command and converts the user action command into a device action resource URI. The device action resource URI is published on the relevant devices based on the capability—device mapping result from the capability co-relator module 512 and success/failure notification will be sent to the mobile device based on the result of the action.

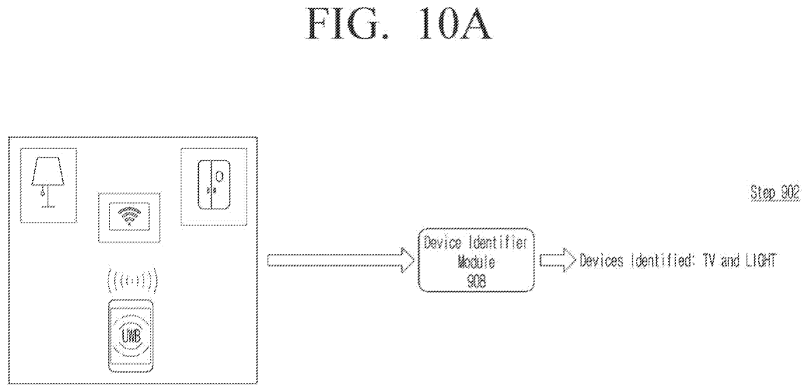

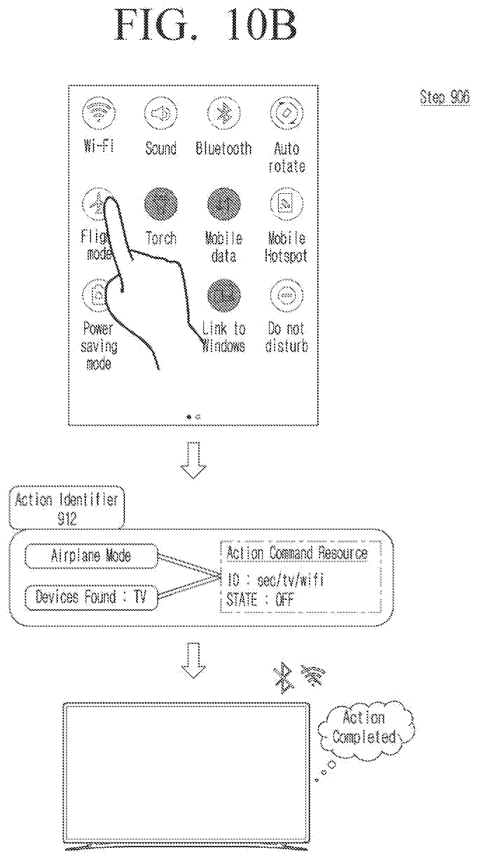

FIGS. 10A-10B further illustrate a device-identifier and an action-identifier according to an embodiment. FIGS. 10A-10B further illustrate the Device-identifier module 908 and the Action-identifier module 912 depicted in FIG. 9.

FIG. 10A illustrates the device identifier 908 uses the UWB data and filters only devices to which the mobile device is pointing to. The device to which the mobile device is pointing to may be determined based on the directional capability of the UWB. The angle between the axis of the UWB transmitter and a signal received back from the device is used for precisely pin pointing the IoT device toward which the mobile device is pointing.

FIG. 10B illustrates an action identifier module 912 parsing the user action command and converting the user action command into a device action resource URI. Based on the icon as selected, the corresponding devices list is fetched from the icon-capability table. The device action resource URI is published to the relevant devices and a success/failure notification will be sent to the mobile device based on the result of the action.

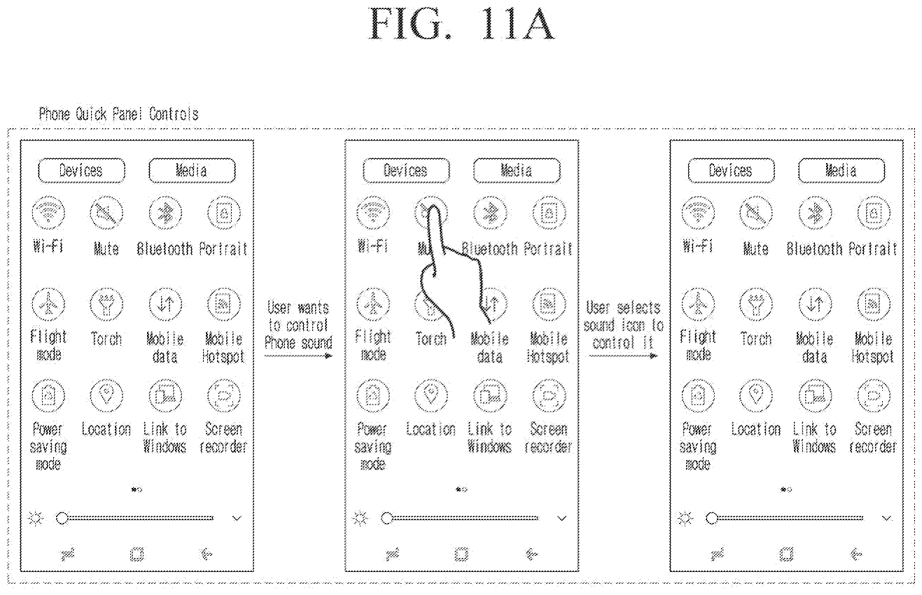

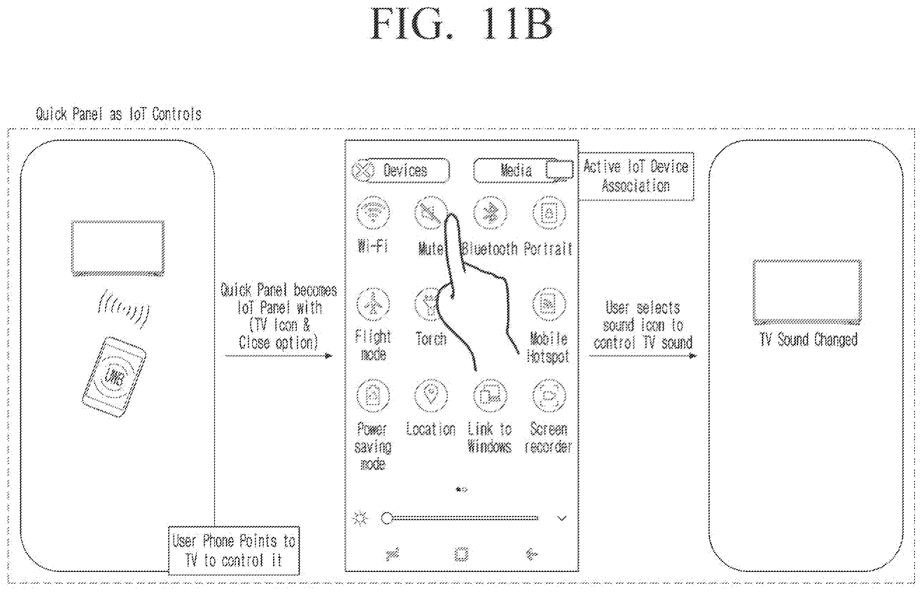

FIGS. 11A and 11B illustrate phone quick-panel controls and quick-panel as IoT Controls, according to embodiments.

FIG. 11A illustrates that a mobile device is not Pointing to any IOT Device, so there is no association with an IOT Device. Accordingly, a user interface of the mobile device acts as a Normal Control and displays Phone Controls.

FIG. 11B illustrates that a mobile device is Pointing to an IOT Device (e.g., a smart TV), so there is an Association created with the IOT Device (with IoT device Icon and Close). The mobile device will therefore act as a IoT quick panel control. In an example embodiment, the association may be valid for a certain amount of time (e.g., 10 sec) that is configurable and the mobile device waits for a selection for the certain amount of time. In the absence of a selection, the user interface of the mobile device changes back to Phone Controls.

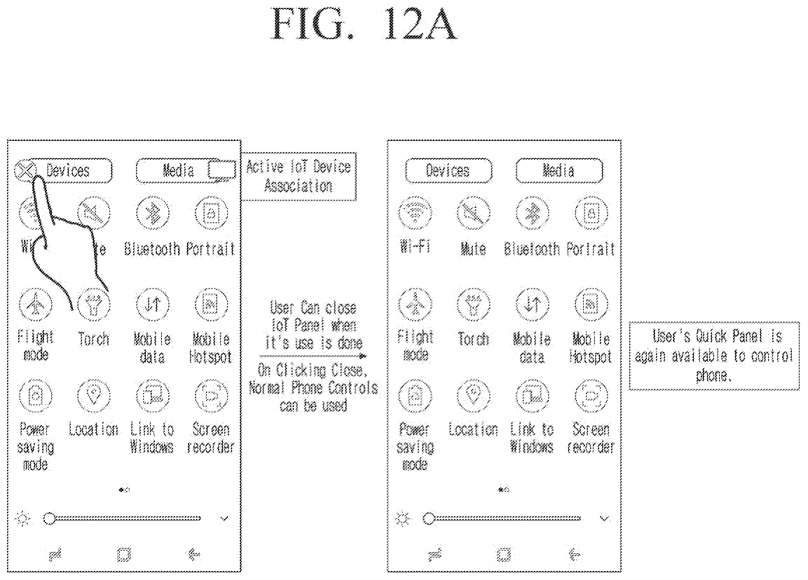

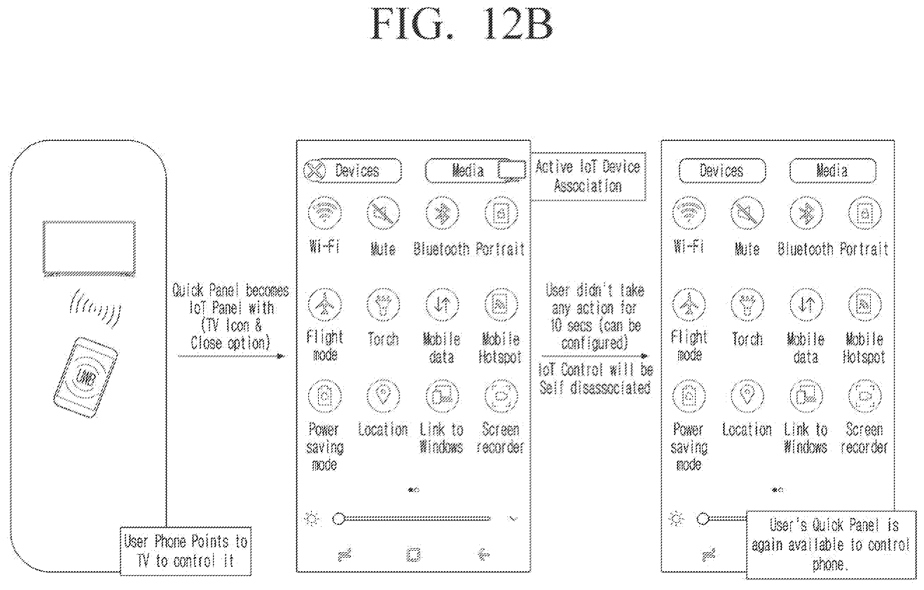

FIGS. 12A-12B illustrate examples of IoT control disassociation, according to an embodiment.

FIG. 12A illustrates a first approach of transformation of the Quick Panel from IoT to Phone Controls. User IoT quick panel control is “disassociated” in response to selection of a close-button (e.g., a user clicks on a close button). Accordingly, the user interface will work as normal phone control.

FIG. 12B illustrates an IoT Control Disassociation upon timeout due to no action. Since no action has been received for a threshold amount of time (e.g., 10 seconds), the IoT quick panel control is disassociated. The threshold amount of time may be configurable. Now the quick panel will work as Normal Phone Control.

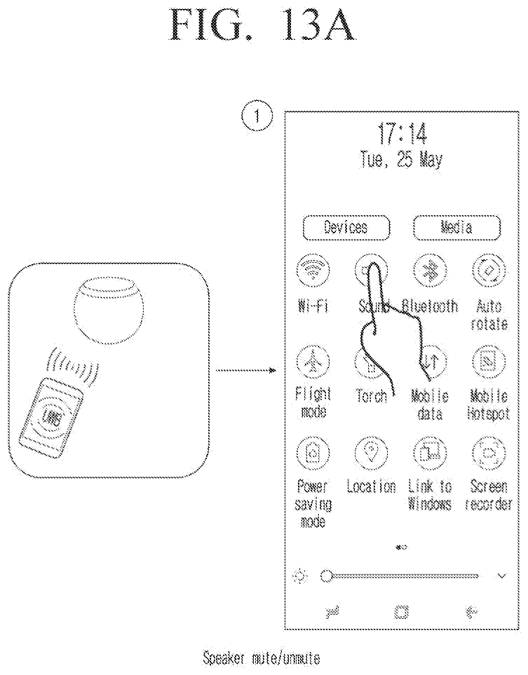

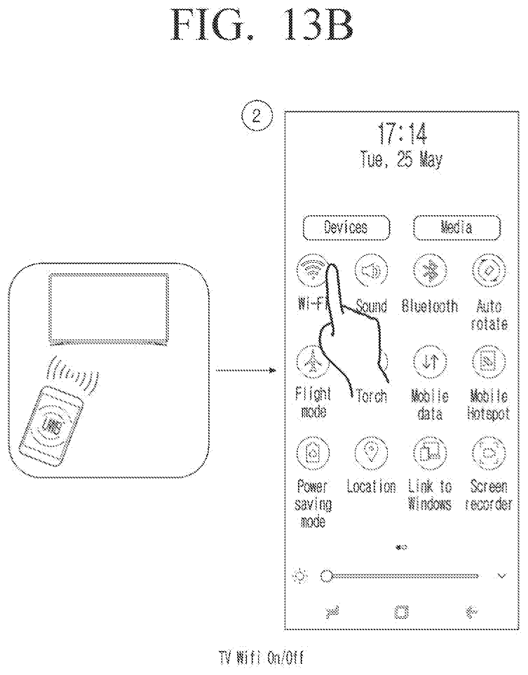

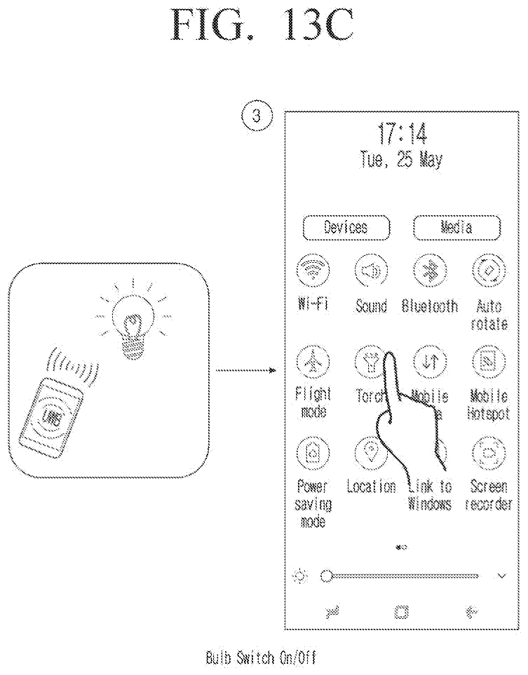

FIGS. 13A-13C depict examples of controlling common IoT Controls from a Quick Panel, according to an embodiment. FIGS. 13A-13C illustrate control of some most commonly used IoT controls by providing one “TAP” access through a Quick Panel Control. Examples in FIG. 13A-13C include speaker mute/unmute, TV WiFi On/Off, Bulb Switch On/Off, respectively.

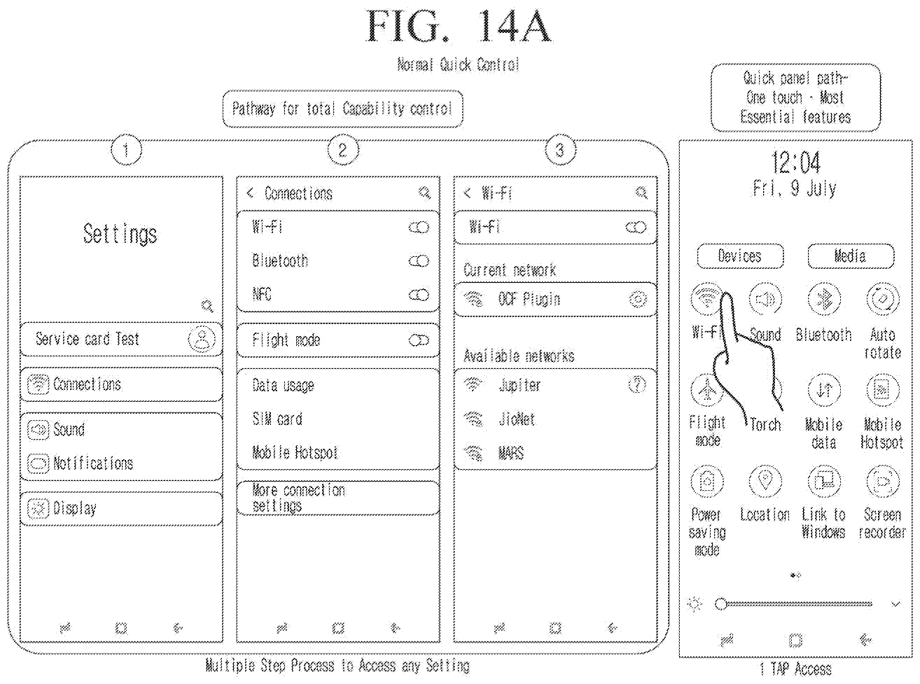

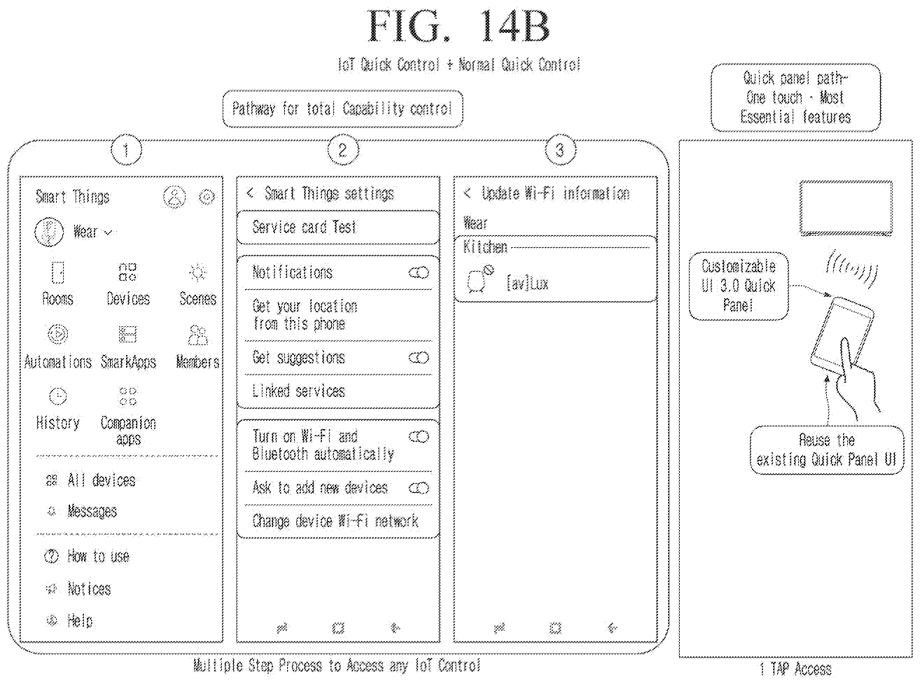

FIGS. 14A-14B depict an example of providing one-touch access to a customizable quick panel according to an embodiment. FIGS. 14A-14B intuitively reuse the existing quick panel icons and accordingly render ONE touch access to a customizable Quick Panel. Such analogy with quick-panel is illustrated in FIGS. 14A-14B where commonly used features may be accessed from Quick Panel and complete functionality of an IoT device may be controlled. FIG. 14A illustrates a Normal Quick Control. FIG. 14B illustrates a combination of IoT Quick Control and a Normal Quick Control, according to an embodiment. FIG. 14B illustrates a Quick panel path or one-touch based path for most essential features.

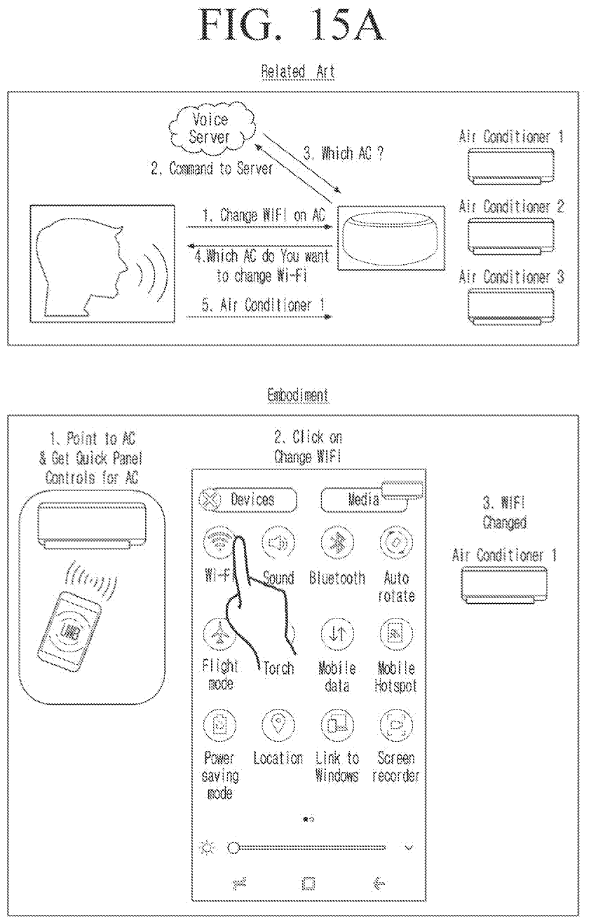

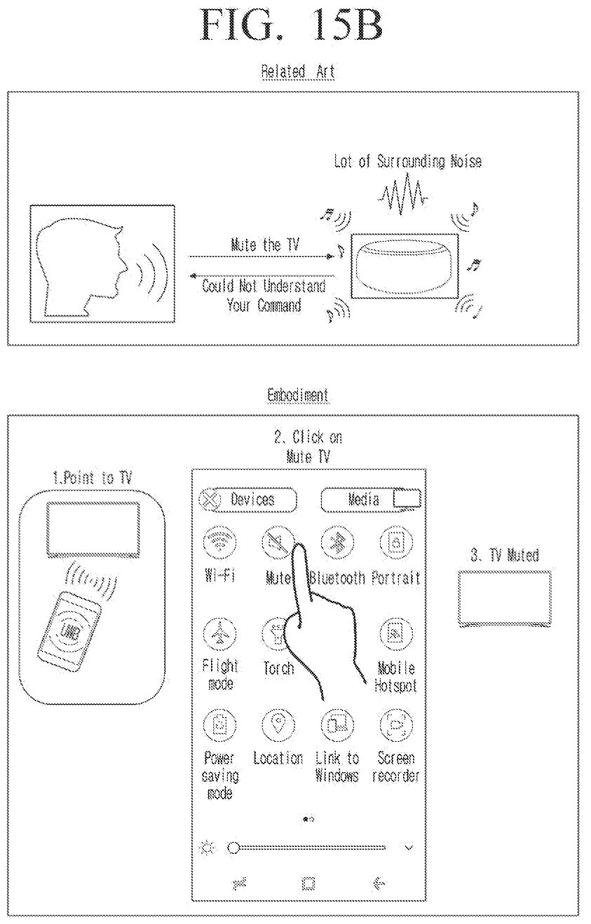

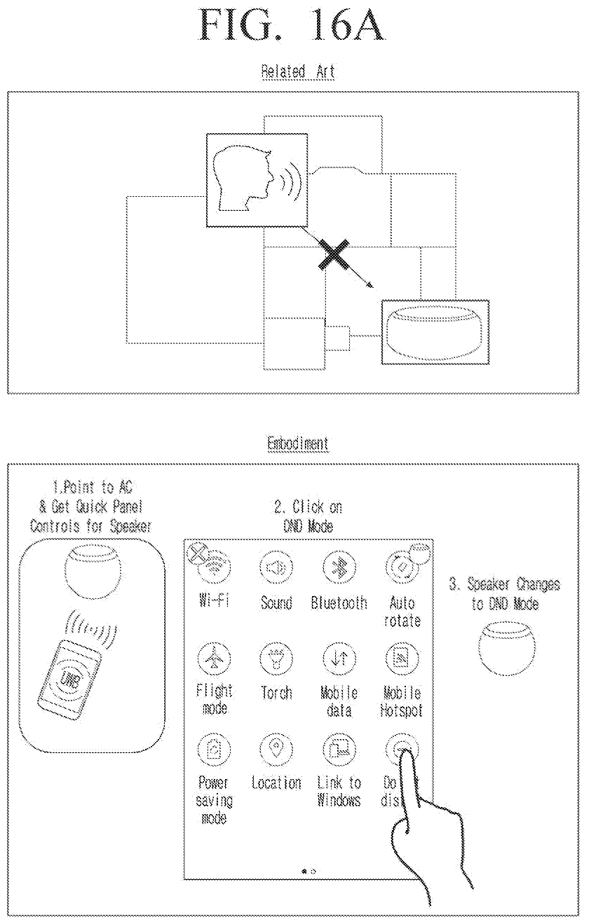

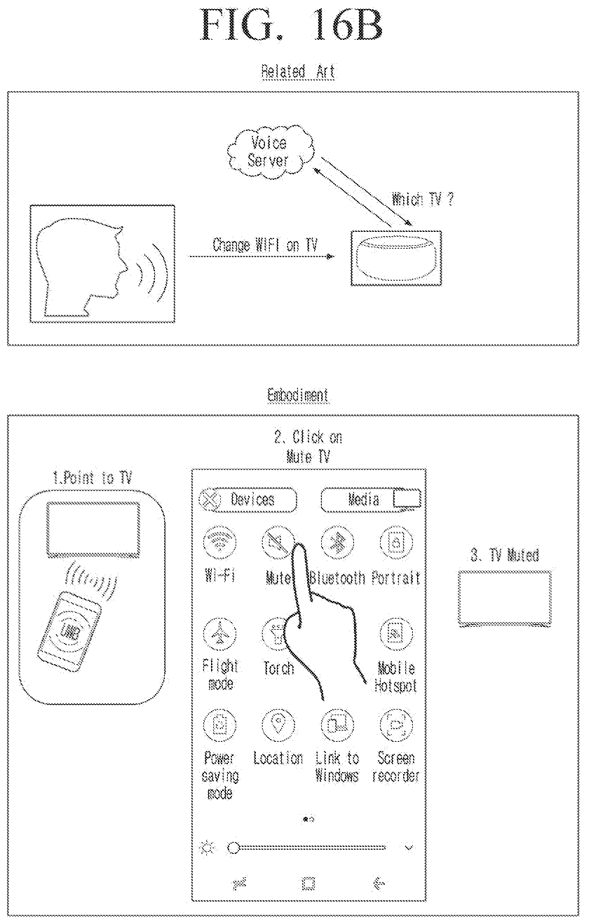

FIGS. 15A-15B and 16A-16B depict a comparison between related art methods and methods according to various embodiments.

In FIG. 15A, refers related art method depicts multiple user interactions involved if a user has similar devices such as TV and AC. Since there are three Air Conditioners, the whole Command Processing can be lot delayed thereby annoying the user. In contrast, the method according to various embodiments allows for a single & quick user Interaction to achieve action.

In FIG. 15B, a voice assistant is often known to fail for noisy environment. A Common Problem with Voice Assistant is an incapability to process commands in a High Noise Environment which can be annoying to user. In contrast, the method according to various embodiments may work in any Noisy Environment and is single touch based.

FIG. 16A illustrates a proximity of a user with a home assistant such as Alexa. Both User and the home assistant may be in different Rooms thus Voice Command is not possible. In contrast, the method according to various embodiments allows pointing to any IoT device in proximity. That is, the method according to various embodiments allows pointing to any IoT device in proximity of the UWB transmitter, even though the IoT device may be in another room.

FIG. 16B illustrates a voice command processing wherein Latency and Cloud Infra Cost are involved. The voice command processing may involve a delay of 4-5 seconds to process a voice command because the voice command is processed via cloud. Also, every voice transaction is associated with a cost. In contrast, the method according to various embodiments allows fast processing to the extent of less than a 1 sec. There is no Cloud Cost Involved for Voice Processing.

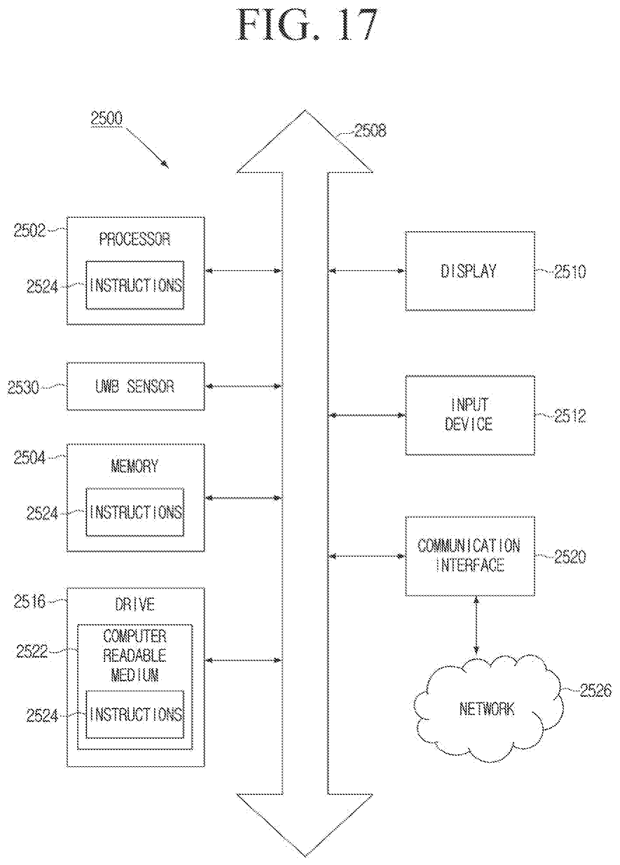

FIG. 17 illustrates an exemplary implementation in accordance with an embodiment. FIG. 17 illustrates a hardware configuration of device mobile device in FIGS. 2A-16B. The mobile device is illustrated as a computer system 2500. The computer system 2500 may include a set of instructions (e.g., program code) that may be executed to cause the computer system 2500 to perform any one or more of the methods descried with reference to FIGS. 2A-16B. For example, the program code may be program code of implementing any of the modules herein. The computer system 2500 may operate as a standalone device or may be connected, e.g., using a network, to other computer systems or peripheral devices.

In a networked deployment, the computer system 2500 may operate in the capacity of a server or as a client user computer in a server-client user network environment, or as a peer computer system in a peer-to-peer (or distributed) network environment. The computer system 2500 may also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 2500 is illustrated, the term “system” shall also be taken to include any collection of systems or sub-systems that individually or jointly execute a set, or multiple sets, of instructions to perform one or more computer functions.

The computer system 2500 may include a processor 2502 (e.g., a central processing unit (CPU), a graphics processing unit (GPU), or both). The processor 2502 may be a component in a variety of systems. For example, the processor 2502 may be part of a personal computer or a workstation. The processor 2502 may be one or more processors, digital signal processors, application-specific integrated circuits, field-programmable gate arrays, servers, networks, digital circuits, analog circuits, combinations thereof, or other now known or later developed devices for analyzing and processing data. The processor 2502 may implement a software program, such as code generated manually (i.e., programmed).

The computer system 2500 may include a memory 2504, such as a memory 2504 that may communicate and be accessed via a bus 2508. The memory 2504 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, memory 2504 may include a cache or random access memory for the processor 2502. In alternative examples, the memory 2504 may be separate from the processor 2502, such as a cache memory of a processor, the system memory, or other memory. The memory 2504 may be an external storage device or database for storing data. The memory 2504 may be operable to store instructions (or program code) executable by the processor 2502. The functions, acts or tasks illustrated in the figures or described may be performed by the programmed processor 2502 for executing the instructions stored in the memory 2504. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 2500 may or may not further include a display 2510, such as a liquid crystal display (LCD), an organic light-emitting diode (OLED), a flat panel display, a solid-state display, a cathode ray tube (CRT), a projector, a printer or other now known or later developed display device for outputting determined information. The display 2510 may act as an interface for the user to see the functioning of the processor 2502, or specifically as an interface with the software stored in the memory 2504 or the drive 2516.

The computer system 2500 may include a ultra wide band (UWB) sensor. The UWB sensor may sense devices within a threshold proximity of the computer system 2500.

Additionally, the computer system 2500 may include an input device 2512 configured to allow a user to interact with any of the components of system 2500. The computer system 2500 may also include a disk or optical drive 2516. The disk drive 2516 may include a computer-readable medium 2522 in which one or more sets of instructions 2524, e.g. software, can be embedded. Further, the instructions 2524 may embody one or more of the methods or logic as described. In a particular example, the instructions 2524 may reside completely, or at least partially, within the memory 2504 or within the processor 2502 during execution by the computer system 2500.

The present disclosure contemplates a computer-readable medium that includes instructions 2524 or receives and executes instructions 2524 responsive to a propagated signal so that a device connected to a network 2526 may communicate voice, video, audio, images, or any other data over the network 2526. Further, the instructions 2524 may be transmitted or received over the network 2526 via a communication port or interface 2520 or using a bus 2508. The communication port or interface 2520 may be a part of the processor 2502 or maybe a separate component. The communication port 2520 may be created in software or maybe a physical connection in hardware. The communication port 2520 may be configured to connect with a network 2526, external media, the display 2510, or any other components in system 2500, or combinations thereof. The connection with the network 2526 may be a physical connection, such as a wired Ethernet connection or may be established wirelessly as discussed later. Likewise, the additional connections with other components of the system 2500 may be physical or may be established wirelessly. The network 2526 may alternatively be directly connected to the bus 2508.

The network 2526 may include wired networks, wireless networks, Ethernet AVB networks, or combinations thereof. The wireless network may be a cellular telephone network, an 802.11, 802.16, 802.20, 802.1Q or WiMax network. Further, the network 826 may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet-switched network transmissions (e.g., TCP/IP, UDP/IP, HTML, and HTTP) may be used.

The present disclosure provides an intelligent intuitive way of Contextual Mapping & Association of IoT Device Services to a User Mobile Panel. In an IoT environment, the present disclosure provides detecting a selection of a quick setting control panel and based on the selection changing the state of an IoT device which changing is analogous to actions normally taken on a mobile device. In an IoT environment, based on the mobile device pointing at multiple devices, the present disclosure provides detecting a selection of a quick setting control panel and taking a joint action on the IoT devices which is analogous to actions normally taken on a mobile device.

Quick Panel Controls are designed to control commonly used settings/controls using one TAP access which is a common feature across all mobile devices compared to 3-4 steps required to control any common used capability (Wifi Change, DND Mode, Power Saving Mode) from any IoT app.

While specific language has been used to describe the various embodiments, any limitations arising on account of the same are not intended. As would be apparent to a person in the art, various working modifications may be made to the embodiments as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to the problem and any component(s) that may cause any benefit, advantage, or solution to occur or become more pronounced are not to be construed as a critical, required, or essential feature or component of any or all the claims.

What we claim is:

1. A method comprising:
detecting, by a processor of a mobile device, a plurality of user actionable buttons present in a quick-setting menu of the mobile device;
detecting, by the processor, one or more Internet of Things (IoT) devices within a pre-defined proximity of the mobile device; and
mapping, by the processor, a plurality of operation control parameters of each of the one or more IoT devices that are detected with one or more user actionable buttons of the plurality of user actionable buttons present in the quick setting menu of the mobile device to allow control, through the quick-setting menu, of the one or more IoT devices by the one or more user actionable buttons.

2. The method of claim 1, further comprising:
detecting, by a ultra wide-band (UWB) sensor in the mobile device, that the mobile device is pointed towards at least one IoT device of the one or more IoT devices within the pre-defined proximity of the mobile phone; and
re-configuring, by the processor, one or more user actionable buttons in the quick setting menu of the mobile device as at least one control button for operating upon the at least one IoT device.

3. The method of claim 2, wherein the reconfiguring comprises identifying one or more operation control parameters of each of the one or more IoT devices that are detected,
wherein the identifying comprising:
fetching, by the processor, device data from a remote server or a cloud server pertaining to the one or more IoT devices that are detected; and
locating the one or more IoT devices that are detected within the predefined proximity and updating a built-in storage of the mobile device.

4. The method of claim 3, further comprising:
extracting, by the processor, capability information of detected IoT devices in the predefined proximity, when capability information of the detected IoT devices is not stored in the built-in storage of the mobile device;
updating, by the processor, the built-in storage with the capability information that is extracted; and
correlating, by a capability co-relator module, similar capabilities of multiple IoT devices based on the capability information that is extracted.

5. The method of claim 1, wherein the mapping corresponds to an intuitive mapping for mapping the one or more user actionable buttons with device capabilities of the one or more IoT devices.

6. The method of claim 1, further comprising displaying a virtual layout on the mobile device to render designated quick setting menu items as the one or more user actionable buttons, the virtual layout being a reusage of an existing user interface UI corresponding to the quick setting menu.

7. The method of claim 1, further comprising:
enabling, by the processor, control of a selected IoT device from the quick setting menu when the mobile device is pointed towards the selected IoT device.

8. The method of claim 7, wherein the enabling control comprises:
determining, by the processor, an inclination angle between axis of a UWB transmitter of the mobile device and a reflected ray from the IoT device;
determining, by the processor, the selected IoT device based on the inclination angle; and
parsing, by the processor, an action command from the mobile device for converting the action command into a device action resource identifier (URI) of the selected IoT device for controlling the selected IoT device.

9. A system comprising:
an ultra wide-band (UWB) sensor configured to detect one or more IoT devices within a pre-defined range of a mobile device; and
a processor communicatively coupled to the UWB sensor, the processor configured to:
identify one or more operation control parameters of each IoT device of the one or more IoT devices that are detected by the UWB sensor;
identify user actionable buttons in a quick setting menu of the mobile device; and
map the one or more operation control parameters of the one or more IoT devices that are detected by the UWB sensor onto one or more user actionable buttons of the user actionable buttons in the quick setting menu to allow user access of the one or more IoT devices from the quick setting menu.

10. The system of claim 9, wherein the processor is further configured to, when the mobile device is pointed towards an IoT device of the one or more IoT devices, enable control of only the IoT device that the mobile device is pointed toward.

11. The system of claim 9, wherein to identify the one or more operation control parameters, the processor is configured to:
fetch device data from a remote server or a cloud server pertaining to the one or more IoT devices that are detected; and
locate the one or more IoT devices that are detected within the predefined proximity and updating a built-in storage of the mobile device.

12. The system of claim 11, wherein the processor is further configured to:
extract capability information of detected IoT devices in the predefined proximity, when capability information of the detected IoT devices is not stored in the built-in storage of the mobile device;
update the built-in storage with the capability information that is extracted; and
correlate, by a capability co-relator module, similar capabilities of multiple IoT devices based on the capability information that is extracted.

13. The system as claimed in claim 9, wherein the mapping corresponds to an intuitive mapping for mapping the one or more user actionable buttons with device capabilities of the one or more IoT devices.

14. The system as claimed in claim 9, wherein the processor is further configured to display a virtual layout on the mobile device to render designated quick setting menu items acting as the one or more actionable buttons, the virtual layout being a reusage of an existing user interface corresponding to the quick setting menu.

15. A method comprising:
detecting, by a processor of an ultra wide-band (UWB) based mobile device, a selection of a quick setting control on the UWB based mobile device while the UWB based mobile device is pointed toward at least one Internet of Things (IoT) device in an IoT environment;
determining, by the processor, at least one operational state for the at least one IoT device, the at least one operational state being linked with at least one functionality of the quick setting control that is selected; and
modifying, by the processor, a current state of the at least one IoT device to the at least one operational state that is determined.
